(19) United States
(12) Patent Application Publication
(10) Pub. No.: US 2007/0286106 A1
(43) Pub. Date: Dec. 13, 2007

(54) METHOD FOR SUPPORTING MULTICAST MESSAGES IN A WIRELESS SYSTEM

(76) Inventors: YANG YANG, Parsippany, NJ (US); Sigen Ye, Randolph, NJ (US); Jialin Zou, Randolph, NJ (US)

Correspondence Address: WILLIAMS, MORGAN & AMERSON, 10333 RICHMOND, SUITE 1100, HOUSTON, TX, 77042, US

(21) Appl. No.: 11/423,346

(22) Filed: Jun. 9, 2006

(51) Int. Cl. H04J 3/24

(52) U.S. Cl. 370/312

(57) ABSTRACT

A method is provided for sending messages to a plurality of access terminals in a wireless network. The method comprises broadcasting a multicast message along with a predetermined address associated with the plurality of access terminals. The multicast message and the address associated with a plurality of access terminals is received at an access terminal. The access terminal compares the received address with a locally stored address, and the message is accepted in response to the received and locally stored addresses being the same. If the received and locally stored addresses are different, then the multicast message is discarded.

### BACKGROUND OF THE INVENTION

1. Field of the Invention

This invention relates generally to telecommunications, and, more particularly, to wireless communications.

2. Description of the Related Art

In the field of wireless telecommunications, such as cellular telephony, a system typically includes a plurality of base stations (e.g., Node Bs) distributed within an area to be serviced by the system. Various Access Terminals (ATs, also known as User Equipment (UE), mobile devices, and the like) within the area may then access the system and, thus, other interconnected telecommunications systems, via one or more of the base stations. Typically, an AT maintains communications with the system as it passes through an area by communicating with one and then another base station, as the AT moves. The AT may communicate with the closest base station, the base station with the strongest signal, the base station with a capacity sufficient to accept communications, etc. Communications between the AT and the base station are wireless and are often referred to as taking place over the air interface.

Communications between the ATs and the base stations may include voice and/or high-speed data. High speed wireless data systems such as Evolution-Data Optimized (EVDO Rev.A), Universal Mobile Telecommunications System (UMTS), High-Speed Downlink Packet Access (HSDPA), E-DCH and Evolution Data and Voice (EVDV) have significantly improved the air interface channel data rates to support various packet data services that require high-speed channels. In addition, multiple standards are defined to efficiently support applications that require large-data transfers, such as continuously running data flows for broadcast or multicast over the air interface.

However, support for fast and flexible transmissions of short messages or data information to a group of users (active or idle) is lacking in all existing 3G air interface standards. Currently, there is no per-message multicast capability in existing cellular wireless standards. Multicast messages are sent using a unicast method to individual users. The process involves locating users, setting up traffic channels and sending the message over each traffic channel using unicast messages. This unicast process incurs longer delays and inefficient use of the air interface and system resources.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one aspect of the instant invention, a method is provided for sending messages to a plurality of access terminals. The method comprises broadcasting a multicast message along with a predetermined address associated with the plurality of access terminals.

In another aspect of the instant invention, a method is provided for controllably receiving a broadcast message. The method comprises receiving a multicast message and an address associated with a plurality of access terminals, and comparing the received address with a locally stored address. The message is accepted in response to the received and locally stored addresses being the same, and discarded in response to the received and locally stored addresses being different.

### BRIEF DESCRIPTION OF THE DRAWINGS

The invention may be understood by reference to the following description taken in conjunction with the accompanying drawings, in which like reference numerals identify like elements, and in which:

FIG. 1 is a block diagram of a communications system, in accordance with one embodiment of the present invention;

FIG. 2 depicts a block diagram of one embodiment of a base station, an access terminal and a radio network controller used in the communications system of FIG. 1;

FIG. 3 is one embodiment of a flowchart representation of a method that may be used by the access terminals of FIGS. 1 and 2 to receive and display multicast messages directed to it; and

FIG. 4 is one embodiment of a flowchart representation of a method that may be used by the access network of FIGS. 1 and 2 to broadcast multicast messages to a multicast group.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation may be described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

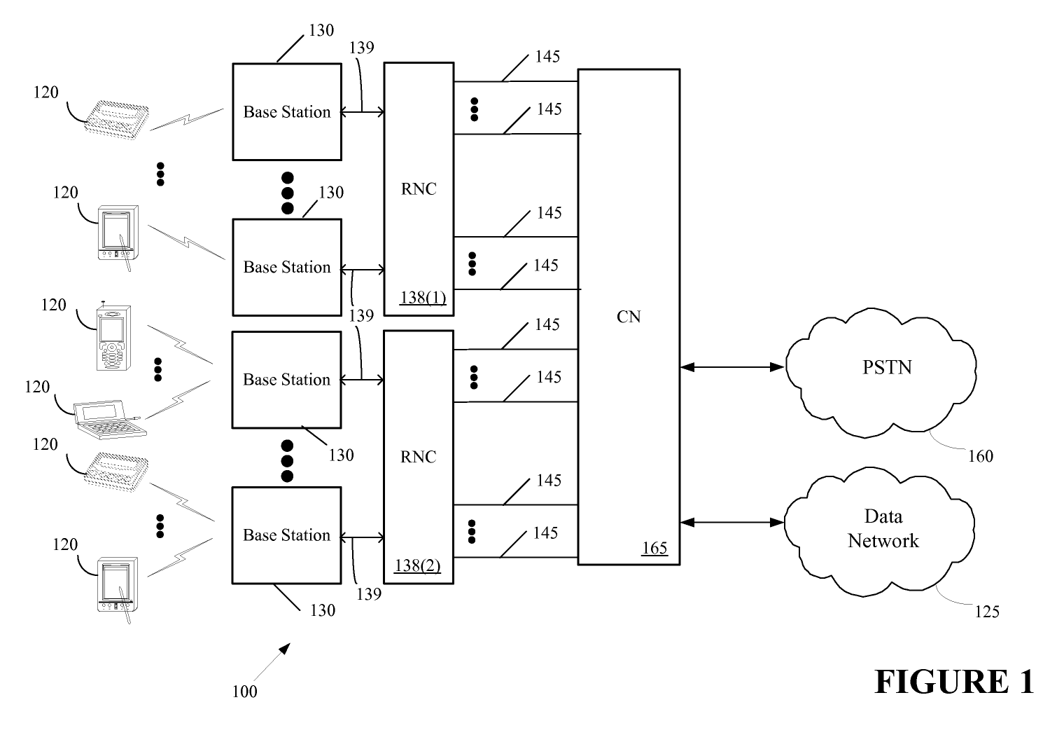

Turning now to the drawings, and specifically referring to FIG. 1, a communications system 100 is illustrated, in accordance with one embodiment of the present invention. For illustrative purposes, the communications system 100 of FIG. 1 employs an architecture based on the Evolution-Data Optimized (EVDO) standard, although it should be understood that the present invention may be applicable to other systems that support data and/or voice communication. The communications system 100 allows one or more ATs 120 to communicate with a data network 125, such as the Internet, through one or more base stations 130. The AT 120 may take the form of any of a variety of devices, including cellular phones, personal digital assistants (PDAs), laptop computers, digital pagers, wireless cards, and any other device capable of accessing the data network 125 through the base station 130.

In one embodiment, a plurality of the base stations 130 may be coupled to a Radio Network Controller (RNC) 138(1-2) by one or more connections 139. Although two RNCs 138(1-2) are illustrated, those skilled in the art will appreciate that more RNCs 138 may be utilized to interface with a large number of base stations 130. Generally, the RNC 138 provides signaling and traffic processing for each wireless data session. The AT 120, base station 130, RNC 138 and the interfaces between these components comprises a radio access network (RAN).

The RNC 138 is coupled to a Core Network (CN) 165 via a connection 145. Generally, the CN 165 operates as an interface to a data network 125 and/or to a public telephone system (PSTN) 160. The CN 165 performs a variety of functions and operations, such as user authentication, however, a detailed description of the structure and operation of the CN 165 is not necessary to an understanding and appreciation of the instant invention. Accordingly, to avoid unnecessarily obfuscating the instant invention, further details of the CN 165 are not presented herein.

The data network 125 may be a packet-switched data network, such as a data network according to the Internet Protocol (IP). One version of IP is described in Request for Comments (RFC) 791, entitled “Internet Protocol,” dated September 1981. Other versions of IP, such as IPv6, or other connectionless, packet-switched standards may also be utilized in further embodiments. A version of IPv6 is described in RFC 2460, entitled “Internet Protocol, Version 6 (IPv6) Specification,” dated December 1998. The data network 125 may also include other types of packet-based data networks in further embodiments. Examples of such other packet-based data networks include Asynchronous Transfer Mode (ATM), Frame Relay networks, and the like.

As utilized herein, a “data network” may refer to one or more communication networks, channels, links, or paths, and systems or devices (such as routers) used to route data over such networks, channels, links, or paths.

Thus, those skilled in the art will appreciate that the communications system 100 facilitates communications, such as short-message multicast communications, between the ATs 120 and the data network 125. It should be understood, however, that the configuration of the communications system 100 of FIG. 1 is exemplary in nature, and that fewer or additional components may be employed in other embodiments of the communications system 100 without departing from the spirit and scope of the instant invention.

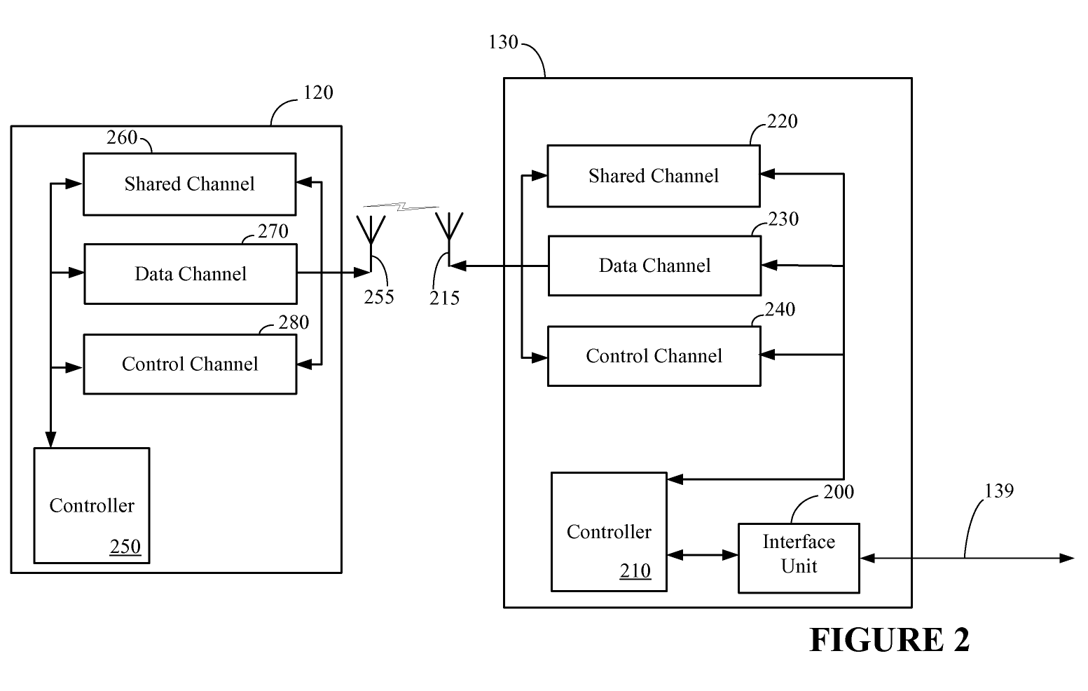

Referring now to FIG. 2, a block diagram of one embodiment of a functional structure associated with an exemplary base station 130 and AT 120 is shown. The base station 130 includes an interface unit 200, a controller 210, an antenna 215 and a plurality of channels: a shared channel 220, a data channel 230, and a control channel 240. The interface unit 200, in the illustrated embodiment, controls the flow of information between the base station 130 and the RNC 138 (see FIG. 1). The controller 210 generally operates to control both the transmission and reception of data and control signals over the antenna 215 and the plurality of channels 220, 230, 240 and to communicate at least portions of the received information to the RNC 138 via the interface unit 200. For example, one piece of information transmitted from the base station 130 to the RNC 138 is information used by the base station 130 to communicate with the ATs 120.

The AT 120 shares certain functional attributes with the base station 130. For example, the AT 120 includes a controller 250, an antenna 255 and a plurality of channels: a shared channel 260, a data channel 270, and a control channel 280. The controller 250 generally operates to control both the transmission and reception of data and control signals over the antenna 255 and the plurality of channels 260, 270, 280.

Normally, the channels 260, 270, 280 in the AT 120 communicate with the corresponding channels 220, 230, 240 in the base station 130. Under the operation of the controllers 210, 250, the channels 220, 260; 230, 270; 240, 280 are used to effect a controlled scheduling for communications from the AT 120 to the base station 130.

The base station 130 includes an air interface physical channel that is broadcast in nature, so that all ATs 120 within the coverage area can receive a message broadcast over the physical channel. In the illustrated embodiment, the broadcast physical channel may take the form of the shared channel 220.

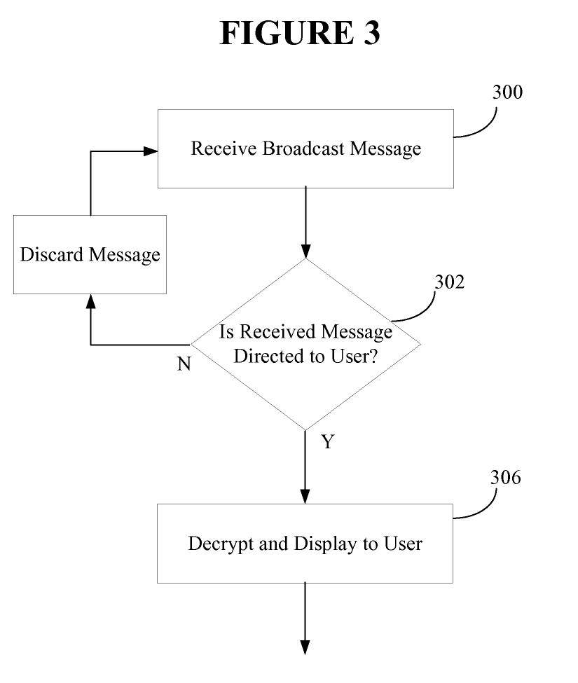

Generally, as shown in the stylized flowchart of FIG. 3, the instant invention is directed to a method that allows short messages to be broadcast to a plurality of ATs 120 using a multicast technique. In one embodiment of the instant invention, the system 100 employs a multicast addressing scheme that allows the ATs 120 to identify whether a broadcast message is addressed to the user. The multicast address may be preconfigured when the user subscribed to the multicast group, and is stored in the ATs 120. The same multicast address is indicated in the multicast packet broadcast by the physical channel, so that the AT 120 can identify those packets directed to it. At block 300, the ATs 120 received a message broadcast by base station 130. The broadcast message includes the preconfigured multicast address. At decision block 302, the ATs 120 determine if the received message is directed to them by comparing the stored multicast address with the received multicast address. If the addresses do not match, then the AT 120 is not a proper recipient of the message, and at block 304 the message is discarded. On the other hand, if the addresses match, then the AT 120 is a proper recipient. Accordingly, control transfers to block 306 where the message is decrypted (if encrypted) and then displayed to the user of the AT 120. Those skilled in the art will appreciate that encryption/decryption is an optional aspect of the instant invention and may be excluded without departing from the spirit and scope of the invention.

In some embodiments of the instant invention, it may be useful to have a security scheme that ensures the information is being received by the authorized or subscribed users only. This can be particularly useful if the information is confidential, or there is a non-trivial likelihood that the multicast addresses are reused in the area. The security scheme may include an encryption scheme that can be applied to the message content. The encryption key may be specific per multicast group. Therefore, only the subscribed users can decode the message content.

Using EVDO as an exemplary technology, one embodiment of the instant invention is described in greater detail below. In an EVDO based system 100, the synchronous control channel and sub-synchronous control channel are monitored by all of the ATs 120, active or idle. Thus, these channels may be effectively used to broadcast the message and multicast address. In the exemplary EVDO based system, new MAC layer attributes called Multicast_ATI_Arrary are defined. Each value corresponds to a multicast group ID. The attributes may be configured and negotiated during session setup.

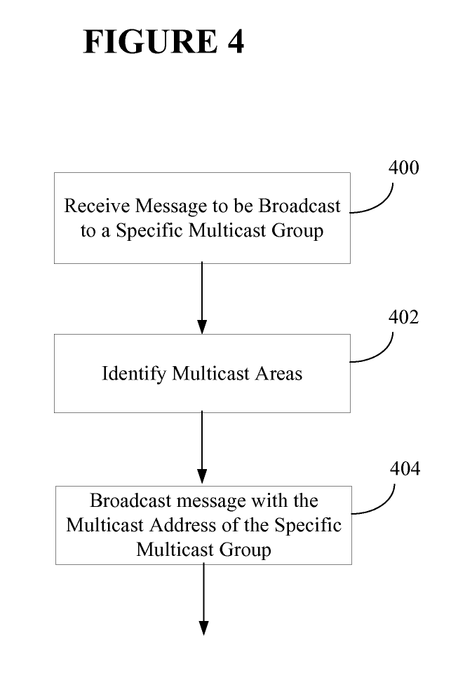

Turning now to FIG. 4, a stylistic flowchart of the operation of the system 100 is shown during a multicast transmission. At block 400, the DO Access Network (AN) receives a message that is to be broadcast to a specific multicast group. The AN identifies the multicast areas based on the multicast group configuration and estimated group members' locations when they are idle. At block 404, the base stations 130 comprising the identified multicast area then transmit, via the synchronous or sub-synchronous control channel, the multicast message indicating MATI in the MAC header followed by the Multicast_ATI that identifies the multicast group. The current Qpage channel can be utilized to notify an idle mobile in the multi-cast group about the imminent multicast message.

As discussed above in conjunction with FIG. 3, when the AT 120 receives the message, it determines if the message is directed to it by examining certain fields contained within the message, such as the ATIType and ATI field to see if the message should be delivered to the upper layer or discarded.

Those skilled in the art will appreciate that the various system layers, routines, or modules illustrated in the various embodiments herein may be executable control units. The controllers may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by the controllers 210, 250, 310 cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. Consequently, the method, system and portions thereof and of the described method and system may be implemented in different locations, such as the wireless unit, the base station, a base station controller and/or mobile switching center. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. It is therefore evident that the particular embodiments disclosed above may be altered or modified and all such variations are considered within the scope and spirit of the invention. Accordingly, the protection sought herein is as set forth in the claims below.

We claim:

1. A method for sending messages to a plurality of access terminals, comprising:
broadcasting a multicast message along with a predetermined address associated with the plurality of access terminals.

2. A method, as set forth in claim 1, further comprising determining a region in which to broadcast the multicast message based on characteristics of the plurality of access terminals.

3. A method, as set forth in claim 2, wherein determining the region in which to broadcast the multicast message based on characteristics of the plurality of access terminals further comprises determining the region in which to broadcast the multicast message based on estimated locations of the plurality of access terminals.

4. A method, as set forth in claim 1, wherein broadcasting the multicast message along with a predetermined address associated with the plurality of access terminals further comprises broadcasting the multicast message over a synchronous control channel.

5. A method, as set forth in claim 1, wherein broadcasting the multicast message along with a predetermined address associated with the plurality of access terminals further comprises broadcasting the multicast message over a sub-synchronous control channel.

6. A method, as set forth in claim 1, further comprising sending a notification to an idle one of the plurality of access terminals that a multicast message will be broadcast.

7. A method, as set forth in claim 6, wherein sending the notification to the idle one of the plurality of access terminals that the multicast message will be broadcast further comprises sending a page signal to the idle one of the plurality of access terminals that the multicast message will be broadcast.

8. A method, as set forth in claim 7, wherein sending a page signal to the idle one of the plurality of access terminals that the multicast message will be broadcast further comprises sending a page signal over a Qpage channel to the idle one of the plurality of access terminals that the multicast message will be broadcast.

9. A method, as set forth in claim 1, further comprises applying an encryption scheme to the multicast message.

10. A method for controllably receiving a broadcast message, comprising:
receiving a multicast message and an address associated with a plurality of access terminals; and
comparing the received address with a locally stored address; and
accepting the multicast message in response to the received and locally stored addresses being the same.

11. A method, as set forth in claim 10, further comprising moving from an idle state to an active state in response to receiving a signal that a multicast message will be broadcast.

12. A method, as set forth in claim 11, wherein moving from an idle state to an active state in response to receiving a page signal that a multicast message will be broadcast further comprises receiving the page signal over a Qpage channel.

13. A method, as set forth in claim 10, wherein receiving the multicast message and the address associated with the plurality of access terminals further comprises receiving the multicast message over a synchronous control channel.

14. A method, as set forth in claim 10, wherein receiving the multicast message and the address associated with the plurality of access terminals further comprises receiving the multicast message over a sub-synchronous control channel.

15. A method, as set forth in claim 10, further comprising applying a decryption scheme to the multicast message.

16. A method, as set forth in claim 10, further comprising, receiving a multicast address during a registration process and saving the multicast address at the locally stored address.

17. A method, as set forth in claim 10, further comprising discarding the multicast message in response to the received and locally stored addresses being different.

18. A method, as set forth in claim 10, further comprising displaying information regarding the multicast message in response to the multicast message being accepted.
